(19) United States
(12) Patent Application Publication
(10) Pub. No.: US 2021/0011149 A1
(43) Pub. Date: Jan. 14, 2021

(54) InSAR and GNSS weighting method for three-dimensional surface deformation estimation

(71) Applicant: Central South University, Changsha (CN)

(72) Inventors: Jun Hu, Changsha (CN); Jihong Liu, Changsha (CN); Zhiwei Li, Changsha (CN); Jianjun Zhu, Hunan (CN)

(21) Appl. No.: 17/035,771

(22) Filed: Sep. 29, 2020

Related U.S. Application Data
(63) Continuation of application No. PCT/CN2020/091273, filed on May 20, 2020.

(30) Foreign Application Priority Data
May 21, 2019 (CN) 201910423735.8

(51) Int. Cl. G01S 13/90; G01S 19/43; G01S 19/14; G06F 17/16

(52) U.S. Cl. CPC G01S 13/9023; G06F 17/16; G01S 19/14; G01S 19/43

(57) ABSTRACT

An InSAR and GNSS weighting method for three-dimensional surface deformation estimation includes steps of: Step 1: establishing a functional relationship between three-dimensional deformation d⁰ of an unknown point and a certain amount of InSAR/GNSS data Lᵢ of surrounding points by using ascending and descending orbit InSAR data and GNSS data based on a strain model and observation imaging geometry: Step 2: performing relative weighting on Kᵢ observation data in the InSAR/GNSS data Lᵢ, and determining an initial weight matrix Wᵢ of various InSAR/GNSS observations; Step 3: determining accurate weight matrix Ŵᵢ between the various InSAR/GNSS observations by variance component estimation, and solving the three-dimensional deformation d⁰ based on a least square method; and Step 4: performing the steps 1-3 for each surface point to estimate a high-accurate three-dimensional surface deformation field by fusing InSAR and GNSS.

### CROSS REFERENCE OF RELATED APPLICATION

The application is a continuation application of a PCT application No. PCT/CN2020/091273, filed on May 20, 2020; and claims the priority of Chinese Patent Application No. CN 201910423735.8, filed to the State Intellectual Property Office of China (SIPO) on May 21, 2019, the entire content of which are incorporated hereby by reference.

### BACKGROUND OF THE PRESENT INVENTION

### Field of Invention

The present invention relates to a technical field of geodetic surveying with remote sensing images, and more particularly to an InSAR and GNSS weighting method for three-dimensional surface deformation estimation.

### DESCRIPTION OF RELATED ARTS

Interferometric Synthetic Aperture Radar (SAR, InSAR) and Global Navigation Satellite System (GNSS) have been widely used to detecting surface deformation caused by earthquakes, volcanoes, underground mining, etc. InSAR technology processes two SAR images of the same area at different times (with an interval ranging from several days to several hundreds of days) to obtain a one-dimensional average deformation result of one resolution unit (several meters to tens of meters) along the line-of-sight (LOS) direction within the interval, wherein the observation accuracy is generally at millimeter or centimeter level. GNSS technology uses a ground receiver to obtain a time-continuous three-dimensional coordinate sequence. The three-dimensional surface deformation at the receiver can be obtained by making the difference between the coordinates of two moments, wherein horizontal accuracy can reach sub-millimeter level and vertical accuracy can reach millimeter level. Therefore, InSAR and GNSS technologies have complementary advantages in surface deformation monitoring, and provide a new idea for obtaining three-dimensional surface deformation with high accuracy and high spatial resolution.

Due to the difference of InSAR and GNSS in deformation observation accuracy, accurately determining the weight ratio between the two types of observations is essential for obtaining high-accuracy three-dimensional surface deformation results. In fact, when detecting surface deformation, InSAR and GNSS are very susceptible to various uncertain factors, such as ionosphere, atmospheric water vapor, and surface vegetation coverage, which makes it difficult to accurately estimate the prior variance information of various observations. Conventionally, the prior variance of GNSS is mainly obtained based on the GNSS network adjustment, while the prior variance of InSAR data is obtained by assuming that there is no deformation in the far-field region, and using the fitting result of the semi-variogram function as the prior variance of the entire InSAR image. Then, the weight ratio can be determined. However, InSAR observation errors are often different in space, so the weighting accuracy thereof is limited. In addition, through the empirical formula of InSAR observation accuracy and coherence, the prior variance estimate of the observation can also be obtained, but such method is difficult to reflect the influence of the atmospheric long-wave error in the observation.

### SUMMARY OF THE PRESENT INVENTION

An object of the present invention is to solve a problem in the prior art. Accordingly, the present invention provides an InSAR and GNSS weighting method for three-dimensional surface deformation estimation, comprising steps of:

Step 1: establishing a functional relationship between three-dimensional deformation d⁰ of an unknown point and a certain amount of InSAR/GNSS data L of surrounding points by using ascending and descending orbit InSAR data and GNSS data based on a strain model and InSAR imaging geometry;

Step 2: performing relative weighting on Kᵢ observation data in the InSAR/GNSS data Lᵢ, and determining an initial weight matrix Wᵢ of various InSAR/GNSS observations:

Step 3: determining accurate weight matrix Ŵᵢ, between the various InSAR/GNSS observations by variance component estimation, and solving the three-dimensional deformation d based on a least square method; and

Step 4: performing the steps 1-3 for each surface point to estimate a high-accurate three-dimensional surface deformation field by fusing InSAR and GNSS.

Preferably, in the step 1, the functional relationship between the three-dimensional deformation d⁰ of the unknown point and the certain amount of the InSAR/GNSS data Lᵢ of the surrounding points is:

Lᵢ^{k}=Bᵢ^{k}·l

wherein Bᵢ^{k}=B_{geo,i}^{k}·Bₛₘ^{k}; P⁰ is the unknow point; Bₓₘ^{k} is a strain model coefficient matrix;

$${B}_{geo , i}^{k} = \{ \begin{matrix}[ {a}_{i}^{k} {b}_{i}^{k} {c}_{i}^{k} ] , & i = 1 , 2 \\ I , & i = 3\end{matrix} ;$$

l is a 3×3 identity matrix; l is an unknown parameter vector at P⁰; Lᵢ^{k} is the InSAR/GNSS data, and i=1, 2, 3; L₁^{k} and L₂^{k} represents the ascending and descending orbit InSAR data are one value; and L₃^{k} indicates the GNSS data is a 3×1 vector.

Preferably, the strain model is a physical-mechanical relationship description of surface adjacent point three-dimensional surface deformation; the observation imaging geometry is a geometric relationship description of the InSAR/GNSS observations and the three-dimensional surface deformation;

Preferably, in the step 2, an initial weight of the InSAR/GNSS observations at P^{k} is determined as:

$${W}_{i}^{k} = \{ \begin{matrix}exp ( - \frac{{( {D}^{k} )}^{2}}{{( {D}_{0} )}^{2}} ) , & i = 1 , 2 \\ exp ( - \frac{{( {D}^{k} )}^{2}}{{( {D}_{0} )}^{2}} ) \cdot {[ 1 , 1 , 0.5 ]}^{T} , & i = 3\end{matrix}$$

wherein Wᵢ^{k} is the initial weight at P^{k}; D^{k}={square root over ((Δx^{e(k)})²+(Δx^{n(k)})²+(Δx^{u(k)})²)} is a distance between P^{k} and P⁰; D₀ is an inverse distance weighted attenuation factor:
the initial weight matrix Wᵢ of various observations is determined as:

Wᵢ=diag(Wᵢ′)

wherein Wᵢ′=[(Wᵢ¹)^{T}, (Wᵢ²)^{T}, . . . , (Wᵢ^{K}^{ᵢ})^{T}]^{T}; Wᵢ=diag(Wᵢ′) is a diagonal matrix whose diagonal elements are elements in the vector W′ᵢ in sequence.

Preferably, the inverse distance weighted attenuation factor D₀ is determined as:

$${D}_{0} = \frac{1}{{K}^{′} {K}_{3}^{′}} {\sum }_{{k}^{′} = 1}^{{K}^{′}} {\sum }_{{k}_{s}^{′} = 1}^{{K}_{s}^{′}} {D}^{{k}^{′} {k}_{s}^{′}}$$

wherein K′ is a total quantity of GNSS sites in an entire deformation field, K′₃ represents a quantity of GNSS sites closest to P⁰; K′₃ ranges from 4 to 6; D^{k′k′}^{ₛ} is a distance between a site k′ among all K′ GNSS sites and a site k′₃ among the K′₃ GNSS sites closest to P⁰.

Preferably, the step 3 specifically comprising steps of:
determining the accurate weight matrix Ŵᵢ and a unit weight error σᵢ² of the various InSAR/GNSS observations by the variance component estimation, and solving the three-dimensional deformation d⁰ based on the least square method; wherein

Mᵢ=Bᵢ^{T}WⁱBᵢ,Nᵢ=Bᵢ^{T}WⁱLⁱ,M=Σᵢ₌₁³Mᵢ,N=Σᵢ₌₁³Nᵢ, then:

l=M⁻¹N (10)

and according to the variance component estimation:

σ²=Ψ⁻¹δ (11)

wherein,

σ²=[σ₁² σ₂² σ₃²]^{T} is unit weight error estimation of the various observations: Ψ is a transformation matrix; and δ is an observation correction quadratic vector;

updating the weight Wᵢ of the various observations by an equation (13):

$${\hat{W}}_{1} = {W}_{1} , {\hat{W}}_{2} = \frac{{σ}_{1}^{2}}{{σ}_{2}^{2} {W}_{2}^{- 1}} , {\hat{W}}_{3} = \frac{{σ}_{1}^{2}}{{σ}_{3}^{2} {W}_{3}^{- 1}} \qquad ( 13 )$$

using the equation (13) to update the weight of the observations, and then recalculating the equations (10) and (11); iterating the process until the unit weight error of the various observations satisfies a difference of σᵢ² is less than a threshold Δσ; and

obtaining a high-accurate three-dimensional surface deformation result according to the equation (10), which is 1^{st}, 2^{nd} and 3^{rd} elements of the unknown parameter vector l.

Preferably, the transformation matrix Ψ is:

$$Ψ = [ \begin{matrix}{K}_{1} - 2 tr ( {M}^{- 1} {M}_{1} ) + {tr ( {M}^{- 1} {M}_{1} )}^{2} & tr ( {M}^{- 1} {M}_{1} {M}^{- 1} {M}_{2} ) & tr ( {M}^{- 1} {M}_{1} {M}^{- 1} {M}_{3} ) \\ tr ( {M}^{- 1} {M}_{1} {M}^{- 1} {M}_{2} ) & {K}_{2} - 2 tr ( {M}^{- 1} {M}_{2} ) + {tr ( {M}^{- 1} {M}_{2} )}^{2} & tr ( {M}^{- 1} {M}_{2} {M}^{- 1} {M}_{3} ) \\ tr ( {M}^{- 1} {M}_{1} {M}^{- 1} {M}_{2} ) & tr ( {M}^{- 1} {M}_{2} {M}^{- 1} {M}_{3} ) & {K}_{3} - 2 tr ( {M}^{- 1} {M}_{3} ) + {tr ( {M}^{- 1} {M}_{3} )}^{2}\end{matrix} ] .$$

Preferably, the observation correction quadratic vector δ is:

δ=[ν₁^{T}W₁ν₁ν₂^{T}W₂ν₂ν₃^{T}W₃ν₃]^{T}

wherein observation correction νᵢ=Bᵢ·l·Lᵢ.

Preferably, in iterating the process until the unit weight error of the various observations satisfies the difference σᵢ² is less than the threshold Δσ, Δσ²=1 mm².

Compared with the prior art, the present invention has the following beneficial effects: the present invention provides the InSAR and GNSS weighting method for three-dimensional surface deformation estimation, which fuses InSAR and GNSS to estimate the three-dimensional surface deformation, wherein a functional relationship between InSAR/GNSS observations and the three-dimensional surface deformation of the unknown point is established based on the strain model. At the same time, the variance component estimation is used to accurately determine the weight ratio between the two types of observations of InSAR and GNSS. Finally, based on the least square method, the three-dimensional surface deformation is accurately estimated. Conventional methods require a large amount of time-series InSAR/GNSS data to provide redundant observations for weighting by variance component estimation, which is not suitable for instantaneous deformations (like volcanoes, earthquakes, etc.). The present invention uses the strain model to provide redundant observations in space, so that the variance component estimation can obtain accurate InSAR/GNSS weight ratio while lacking time-series data, thereby effectively improving accuracy and universality of three-dimensional surface deformation estimation with fused InSAR and GNSS.

### BRIEF DESCRIPTION OF THE DRAWINGS

The present invention can be further understood from the following description in conjunction with the accompanying drawings. Components in the drawings are not necessarily drawn to scale, but emphasis is placed on showing principles of embodiments. In different views of the drawings, the same reference numerals designate corresponding parts.

FIG. 1 is a flow chart of a three-dimensional surface deformation estimation method with fused InSAR and GNSS based on variance component estimation of the present invention;

FIG. 2 is a comparison of three-dimensional surface deformation fields obtained by the method of the present invention and a conventional method, and an original simulated three-dimensional surface deformation field;

FIG. 3 is simulation deformation data of ascending and descending orbit InSAR according to an embodiment of the present invention.

### DETAILED DESCRIPTION OF THE PREFERRED EMBODIMENT

In order to better explain the present invention to those skilled in the art, embodiments of the present invention will be described clearly and in detail below. At the same time, main formula symbols in the present invention are described as follows:

P: point

x: coordinate of the point

d: three-dimensional surface deformation

l: unknown parameter vector

B: coefficient matrix

L: InSAR/GNSS observation

W: weight of the InSAR/GNSS observation

σ: unit weighted error of the InSAR/GNSS observation

K: quantity of the InSAR/GNSS observations

D: distance between two points

V: variance

Superscript 0/k index number of the point

Subscript i/1/2/3: type index number of the InSAR/GNSS observation

Superscript enu: east-west, north-south and up-down variables related to observation

Subscript enu: east-west, north-south and up-down variables related to unknown parameter

### Embodiment 1

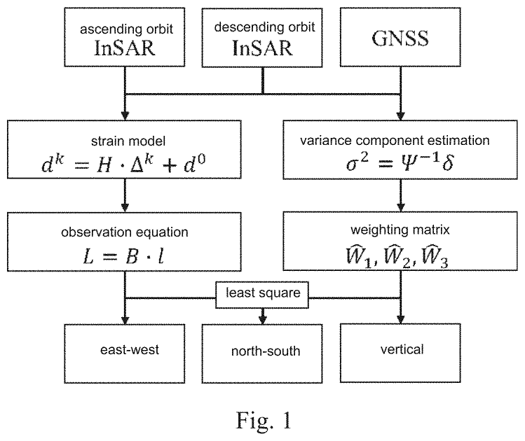

Referring to FIG. 1 the embodiment 1 is described as follows.

Step 1: establishing a functional relationship between three-dimensional deformation d⁰ of an unknown point and a certain amount of InSAR/GNSS data Lᵢ of surrounding points by using ascending and descending orbit InSAR data and GNSS data based on a strain model;

wherein how to determine a quantity of the InSAR/GNSS data used to establish the functional relationship will be described in step 2.

Assuming that a three-dimensional coordinate and a three-dimensional deformation of the unknown point P⁰ are x⁰=[xₑ⁰ xₙ⁰ xₙ⁰]^{T} and d⁰=[dₑ⁰ dₙ⁰ dₙ⁰]^{T}, and a three-dimensional coordinate and a three-dimensional deformation of a surrounding point P^{k} are x^{k}=[xₑ^{k} xₙ^{k} xₙ^{k}]^{T} and d^{k}=[dₑ^{k} dₙ^{k} dₙ^{k}]^{T}, then a following equation can be obtained according to the strain model:

d^{k}=H·Δ^{k}+d⁰ (1)

wherein Δ^{k}=x^{k}−x⁰=[Δxₑ^{k} Δxₙ^{k} Δxₙ^{k}]^{T}. H is an unknown parameter matrix of the stress-strain model, which can be expressed as:

$$H = [ \begin{matrix}{ξ}_{ee} & {ξ}_{en} & {ξ}_{ue} \\ {ξ}_{en} & {ξ}_{nn} & {ξ}_{nu} \\ {ξ}_{us} & {ξ}_{nu} & {ξ}_{nn}\end{matrix} ] + [ \begin{matrix}0 & - {ω}_{en} & {ω}_{eu} \\ {ω}_{en} & 0 & - {ω}_{nu} \\ - {ω}_{eu} & {ω}_{nu} & 0\end{matrix} ] \qquad ( 2 )$$

ξ and ω are a strain parameter and a rotation parameter in the strain model, respectively.

The, the equation (1) can be written as:

d^{k}=Bₛₘ^{k}·l (3)

wherein,

$${B}_{sm}^{k} = [ \begin{matrix}1 & 0 & 0 & Δ {x}_{e}^{k} & Δ {x}_{n}^{k} & Δ {x}_{u}^{k} & 0 & 0 & 0 & - Δ {x}_{n}^{k} & Δ {x}_{u}^{k} & 0 \\ 0 & 1 & 0 & 0 & Δ {x}_{e}^{k} & 0 & Δ {x}_{n}^{k} & Δ {x}_{u}^{k} & 0 & Δ {x}_{e}^{k} & 0 & - Δ {x}_{u}^{k} \\ 0 & 0 & 1 & 0 & 0 & Δ {x}_{e}^{k} & 0 & Δ {x}_{n}^{k} & Δ {x}_{u}^{k} & 0 & - Δ {x}_{e}^{k} & Δ {x}_{n}^{k}\end{matrix} ] .$$

which is a strain model coefficient matrix.

l=[dₑ⁰dₙ⁰d₀^{u}ξₑₑτₑₙξₑᵤξₙₙξₙᵤξᵤᵤωₑₙωₑᵤωₙᵤ]T,

which is the unknown parameter vector at P⁰.

Preferably, it is assumed that there are one or more of ascending orbit InSAR, descending orbit InSAR, and GNSS data at P^{k}, marked as L₁^{k},L₂^{k},L₃^{k}, wherein L₁^{k} and Lₖ² represents the ascending and descending orbit InSAR data are one value; and L₃^{k} indicates the GNSS data is a 3×1 vector, L₃^{k}=[L₃^{e(k)} L₃^{n(k)} L₃^{u(k)}]^{T}. Considering a geometric relationship between InSAR and GNSS observations and the three-dimensional surface deformation, the functional relationship between Lᵢ^{k}(1=1, 2, 3) and the three-dimensional surface deformation d^{k} at P^{k} can be established:

Lᵢ^{k}=B_{geo,i}^{k}·d^{k} (4)

wherein

$${B}_{geo , i}^{k} = \{ \begin{matrix}[ {a}_{i}^{k} {b}_{i}^{k} {c}_{i}^{k} ] , & i = 1 , 2 \\ I , & i = 3\end{matrix} ;$$

l is a 3×3 identity matrix,

$$\{ \begin{matrix}{a}_{i}^{k} = {s}_{i} \cdot sin ( {θ}_{i}^{k} ) sin ( {α}_{i}^{k} - \frac{3 π}{2} ) \\ {b}_{i}^{k} = {s}_{i} \cdot sin ( {θ}_{i}^{k} ) cos ( {α}_{i}^{k} - \frac{3 π}{2} ) \\ {c}_{i}^{k} = cos ( {θ}_{i}^{k} )\end{matrix} , \\ {s}_{i} = \{ \begin{matrix}1 , & InSAR is left view data \\ - 1 , & InSAR is right view data\end{matrix}$$

wherein αᵢ^{k}, θᵢ^{k} are respectively an azimuth angle and an incident angle of a satellite when acquiring the SAR data.

The equations (3) and (4) are combined to obtain:

Lᵢ^{k}=Bᵢ^{k}·l (5)

wherein Bᵢ^{k}=B_{geo,i}^{k}·Bₛₘ^{k}.

Now, the functional relationship between the InSAR/GNSS observations at the surrounding point P^{k} and the unknown parameter vector l at the point P⁰ can be established.

Assuming that there are K₁ ascending orbit InSAR, K₂ descending orbit InSAR, and K₃ GNSS sites around the point P⁰ for estimating the unknown parameter vector l, then:

L=B·l (6)

wherein.

L=[(L₁)^{T},(L₂)^{T},(L₃)^{T}]^{T},Lᵢ=[(Lᵢ¹)^{T},(Lᵢ²)^{T}, . . . ,(Lᵢ^{K}^{ᵢ})^{T}]^{T},

B=[(B₁)^{T},(B₂)^{T},(B₃)^{T}]^{T},Bᵢ=[(Bᵢ¹)^{T},(Bᵢ²)^{T}, . . . ,(Bᵢ^{K}^{ᵢ})^{T}]^{T}.

Step 2: performing relative weighting on K observation data in the various observations, and determining an initial weight matrix Wᵢ of the various observations;

wherein since GNSS sites are relatively sparsely distributed, GNSS site data at different distances from P⁰ should be given different weights. The present invention uses the following equation to determine the initial weight of the InSAR/GNSS observations at P^{k}:

$${W}_{i}^{k} = \{ \begin{matrix}exp ( - \frac{{( {D}^{k} )}^{2}}{{( {D}_{0} )}^{2}} ) , & i = 1 , 2 \\ exp ( - \frac{{( {D}^{k} )}^{2}}{{( {D}_{0} )}^{2}} ) \cdot {[ 1 , 1 , 0.5 ]}^{T} , & i = 3\end{matrix} \qquad ( 7 )$$

wherein D^{k}={square root over ((Δx^{e(k)})²+(Δx^{n(k)})²+(Δx^{u(k)})²)} is a distance between P^{k} and P⁰; D₀ is an inverse distance weighted attenuation factor, which is determined as:

$${D}_{0} = \frac{1}{{K}^{′} {K}_{3}^{′}} {\sum }_{{k}^{′} = 1}^{{K}^{′}} {\sum }_{{k}_{s}^{′} = 1}^{{K}_{s}^{′}} {D}^{{k}^{′} {k}_{s}^{′}} \qquad ( 8 )$$

wherein K′ is a total quantity of the GNSS sites in an entire deformation field, K′₃ represents a quantity of GNSS sites closest to P⁰; according to experience, K′₃ ranges from 4 to 6; D^{k′k′}^{ₛ} is a distance between a site k′ among all K′ GNSS sites and a site k′₃ among the K′₃ GNSS sites closest to P⁰.

It should be noted that vertical GNSS observation accuracy is often lower than horizontal accuracy. Therefore, a weight scale factor of the GNSS vertical observation in equation (7) is 0.5. In practice, the scale factor can be adjusted based on priori variance information of GNSS three-dimensional deformation values.

Then, the initial weight matrix Wᵢ of various observations is determined as:

Wᵢ=diag(Wᵢ′) (9)

wherein Wᵢ′=[(Wᵢ¹)^{T}, (Wᵢ²)^{T}, . . . , (Wᵢ^{K}^{ᵢ})^{T}]^{T}; Wᵢ=diag(W′ᵢ) is a diagonal matrix whose diagonal elements are elements in the vector Wᵢ′ in sequence.

At the same time, when a ratio of the smallest weight to the largest weight in a set of data is less than a certain threshold, the observation corresponding to the smallest weight is negligible during solving the unknown parameter. Therefore, during calculation, the method of the resent invention does not consider the GNSS site whose initial weight

$$exp ( - \frac{{( {D}^{k} )}^{2}}{{( {D}_{0} )}^{2}} )$$

is less than a threshold Wₜₕᵣ. According to experience, Wₜₕᵣ is generally 10⁻⁶.

At this time, the quantity K₃ of the GNSS sites for establishing the functional relationship in the step 1 can be determined. In order to determine the weight more accurately by the variance components estimation, the quantities of different types of the observations should be roughly equal, which means K₁≈K₂≈3K₃ in the present invention. Therefore, K₁/K₂ ascending/descending orbit InSAR data closest to P⁰ are selected according to the present invention to calculate the unknown parameter vector l.

Step 3: determining accurate weight matrix Ŵᵢ between the various InSAR/GNSS observations by variance component estimation and a unit weight error σᵢ², and solving the three-dimensional deformation d⁰ based on a least square method; wherein

Mᵢ=Bᵢ^{T}WⁱBᵢ,Nᵢ=Bᵢ^{T}WⁱLⁱ,M=Σᵢ₌₁³Mᵢ,N=Σᵢ₌₁³Nᵢ, then:

l=M⁻¹N (10)

and according to the variance component estimation:

σ²=Ψ⁻¹δ (11)
wherein,
σ²=[σ₁² σ₂² σ₃²]^{T} is unit weight error estimation of the various observations.

$$Ψ = [ \begin{matrix}{K}_{1} - 2 tr ( {M}^{- 1} {M}_{1} ) + {tr ( {M}^{- 1} {M}_{1} )}^{2} & tr ( {M}^{- 1} {M}_{1} {M}^{- 1} {M}_{2} ) & tr ( {M}^{- 1} {M}_{1} {M}^{- 1} {M}_{3} ) \\ tr ( {M}^{- 1} {M}_{1} {M}^{- 1} {M}_{2} ) & {K}_{2} - 2 tr ( {M}^{- 1} {M}_{2} ) + {tr ( {M}^{- 1} {M}_{2} )}^{2} & tr ( {M}^{- 1} {M}_{2} {M}^{- 1} {M}_{3} ) \\ tr ( {M}^{- 1} {M}_{1} {M}^{- 1} {M}_{2} ) & tr ( {M}^{- 1} {M}_{2} {M}^{- 1} {M}_{3} ) & {K}_{3} - 2 tr ( {M}^{- 1} {M}_{3} ) + {tr ( {M}^{- 1} {M}_{3} )}^{2}\end{matrix} ]$$

is a transformation matrix.

δ=[ν₁^{T}W₁ν₁ν₂^{T}W₂ν₂ν₃^{T}W₃ν₃]^{T} is an observation correction quadratic vector.

νᵢ=Bᵢ·l−Lᵢ is observation correction.

According to the variance component estimation, when the unit weight error of the various observations is approximately equal, that is

σ₁²≈σ₂²≈σ₃² (12)

then the weight matrix of the observations is an optimal weight matrix. Since the initial weight matrix Wᵢ only considers the relative weight between the observations of the same type, and does not consider the weight ratio between the observations of different types, the unit weight error of the various observations obtained by the equation (11) usually cannot satisfy the equation (12). The present invention uses the following equation to update the weight Wᵢ of the various observations with ideas of the variance component estimation:

$${\hat{W}}_{1} = {W}_{1} , {\hat{W}}_{2} = \frac{{σ}_{1}^{2}}{{σ}_{2}^{3} {W}_{2}^{- 1}} , {\hat{W}}_{3} = \frac{{σ}_{1}^{3}}{{σ}_{3}^{2} {W}_{3}^{- 1}} \qquad ( 13 )$$

using the equation (13) to update the weight of the observations, and then recalculating the equations (10) and (11); iterating the process until the unit weight error of the various observations satisfies the equation (12), i.e. a difference of σᵢ² is less than a threshold Δσ; according to the present invention, Δσ²=1 mm².

Then, a high-accurate three-dimensional surface deformation result can be obtained according to the equation (10), which is 1^{st}, 2^{nd}, and 3^{rd} elements of the unknown parameter vector l.

The steps 1-3 are performed for each surface point to estimate a high-accurate three-dimensional surface deformation field by fusing InSAR and GNSS.

### Embodiment 2

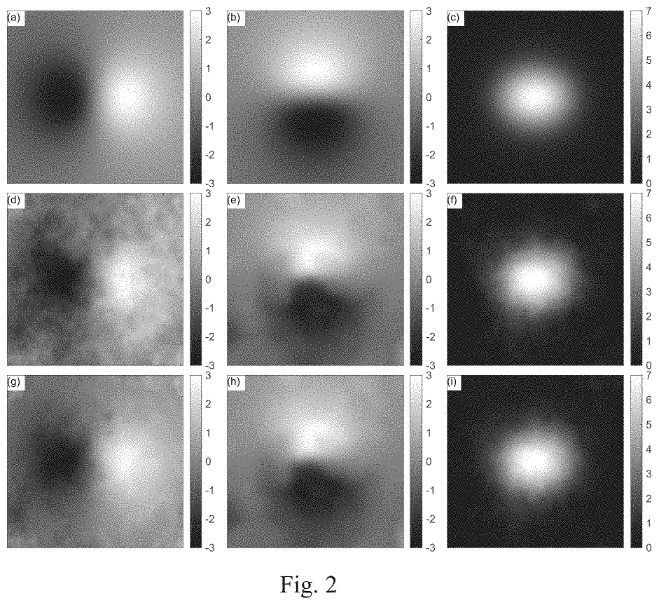

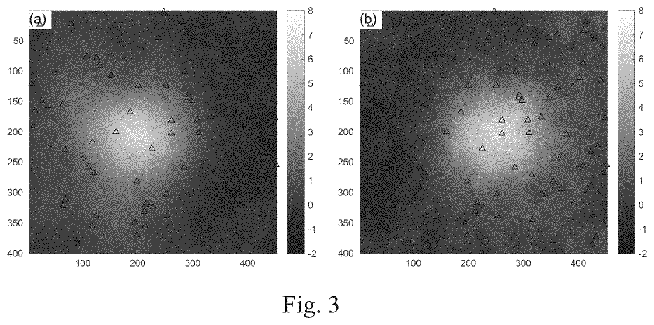

The embodiment 2 verifies the present invention through an experiment, as shown in FIG. 2-3. Referring to FIG. 2, (a)-(c) are the original simulated east-west, north-south and vertical deformation; (d)-(f) are east-west, north-south and vertical deformation data obtained by a conventional method: and (g)-(i) are east-west, north-south and vertical deformation data obtained by the method of the present invention (unit: cm). Referring to FIG. 3, (a) is the ascending orbit InSAR data, and (b) is the descending orbit InSAR data, wherein triangles in FIG. 3 represent location distribution of the GNSS sites (unit: cm).

Simulation data description: (1) simulating the three-dimensional deformation field in east-west, north-south and vertical directions in a certain area (image size 400×450) (as shown in FIG. 2, (a)-(c)); (2) combining imaging geometry of sentinel-1A/B satellite data to calculate the ascending and descending InSAR deformation results, wherein the incident angle and the azimuth angle of the ascending orbit data are 39.3° and −12.2°, respectively; the incident angle and the azimuth angle of the descending orbit data are 33.9° and −167.8°, respectively; (3) adding Gaussian noise with a variance of 4 mm and 6 mm to the ascending and descending InSAR data, respectively: meanwhile adding a certain amount of atmospheric delay error to two scenes of InSAR data, wherein total error root mean squares are 4.9 mm and 6.9 mm, then InSAR observations for the simulation experiment can be obtained (as shown in FIG. 3); (4) at the same time, randomly selecting 100 pixels in the deformation field as positions of the GNSS observation site, wherein the original simulated three-dimensional deformation at the corresponding position is used as the GNSS observation; meanwhile, adding Gaussian noise with a variance of 1 mm to GNSS horizontal deformation observation, and adding Gaussian noise with a variance of 2 mm to GNSS vertical deformation observation, wherein GNSS site distribution is shown by the triangles in FIG. 3.

Conventionally, when fusing InSAR and GNSS to estimate the three-dimensional surface deformation field, an inverse distance weighting method is used to amplify the GNSS prior variance, and InSAR far-field data is used to fit semi-variogram function to obtain prior variance of far-field InSAR observations, and the prior variance is used as prior variance of the entire InSAR image. During solving, the prior variances of InSAR and GNSS observations are used to determine the weights, and the three-dimensional surface deformation is solved with the least square method. The simulation experiment uses the conventional method (FIG. 2, (d)-(f)) and the method of the present invention (FIG. 2, (g)-(i)) to solve the three-dimensional surface deformation field of the simulated data, wherein the root mean square error of the three-dimensional surface deformation field is shown in Table 1.

TABLE 1
root mean square error of the three-dimensional surface
deformation field

| method | east-west (mm) | north-south (mm) | vertical (nm) |
|---|---|---|---|
| conventional | 3.1 | 2.1 | 7.7 |
| present invention | 1.8 | 2.0 | 2.7 |

Referring to Table 1 and FIG. 3, the algorithm of the present invention can obtain a more accurate three-dimensional surface deformation field than the conventional algorithm.

The above embodiments are used to illustrate the present invention, so as to help those of ordinary skill in the art to have a good understanding. Without departing from the spirit and scope of the present invention, various deductions, modifications, and substitutions can also be made to the embodiments of the present invention. These changes and replacements will fall within the scope defined by the claims of the present invention.

It should also be noted that the terms “comprise”, “include” or any other variants thereof are intended to cover non-exclusive inclusion, so that a process, method, commodity or equipment including a series of elements includes not only those elements, but also other elements that are not explicitly listed, or include elements inherent to this process, method, commodity, or equipment. If there is no more restrictions, the element defined by the sentence “including a . . . ” does not exclude the existence of other identical elements in the process, method, commodity, or equipment.

Those skilled in the art should understand that the embodiments of the present invention can be provided as methods, systems, or computer program products. Therefore, the present invention may adopt the form of a complete hardware embodiment, a complete software embodiment, or an embodiment combining software and hardware. Moreover, the present invention may adopt the form of a computer program product implemented on one or more computer-usable storage media (including but not limited to disk storage, CD-ROM, optical storage, etc.) containing computer-usable program codes.

Although the present invention has been described above with reference to various embodiments, it should be understood that many changes and modifications can be made without departing from the scope of the present invention. Therefore, it is intended that the above detailed description be regarded as illustrative rather than restrictive, and it should be understood that the following claims (including all equivalents) are intended to define the spirit and scope of the present invention. The above embodiments should be understood as only used to illustrate the present invention rather than limiting the protection scope of the present invention. Based on the disclosure of the present invention, those skilled in the art can make various changes or modifications to the present invention, and these equivalent changes and modifications also fall within the scope defined by the claims of the present invention.

What is claimed is:

1. An InSAR and GNSS weighting method for three-dimensional surface deformation estimation, comprising steps of:
Step 1: establishing a functional relationship between three-dimensional deformation d⁰ of an unknown point and a certain amount of InSAR/GNSS data Lᵢ of surrounding points by using ascending and descending orbit InSAR data and GNSS data based on a strain model and observation imaging geometry;
Step 2: performing relative weighting on K observation data in the InSAR/GNSS data Lᵢ, and determining an initial weight matrix Wᵢ of various InSAR/GNSS observations;
Step 3: determining accurate weight matrix Ŵᵢ between the various InSAR/GNSS observations by variance component estimation, and solving the three-dimensional deformation d⁰ based on a least square method; and
Step 4: performing the steps 1-3 for each surface point to estimate a high-accurate three-dimensional surface deformation field by fusing InSAR and GNSS.

2. The InSAR and GNSS weighting method, as recited in claim 1, wherein in the step 1, the functional relationship between the three-dimensional deformation d⁰ of the unknown point and the certain amount of the InSAR/GNSS data Lᵢ of the surrounding points is:
Lᵢ^{k}=Bᵢ^{k}·l
wherein Bᵢ^{k}=B_{geo,i}·Bₛₘ^{k}; P⁰ is the unknow point; Bₛₘ^{k} is a strain model coefficient matrix:
$${B}_{geo , i}^{k} = \{ \begin{matrix}[ {a}_{i}^{k} {b}_{i}^{k} {c}_{i}^{k} ] , & i = 1 , 2 \\ I , & i = 3\end{matrix} ;$$
l is a 3×3 identity matrix; l is an unknown parameter vector at P⁰; Lᵢ^{k} is the InSAR/GNSS data, and i=1, 2, 3; L₁^{k} and L₂^{k} represents the ascending and descending orbit InSAR data are one value; and L₃^{k} indicates the GNSS data is a 3×1 vector.

3. The InSAR and GNSS weighting method, as recited in claim 2, wherein in the step 2, the strain model is a physical-mechanical relationship description of surface adjacent point three-dimensional surface deformation: the observation imaging geometry is a geometric relationship description of the InSAR/GNSS observations and the three-dimensional surface deformation;
an initial weight of the InSAR/GNSS observations at P^{k} is determined as:
$${W}_{i}^{k} = \{ \begin{matrix}exp ( - \frac{{( {D}^{k} )}^{2}}{{( {D}_{0} )}^{2}} ) , & i = 1 , 2 \\ exp ( - \frac{{( {D}^{k} )}^{2}}{{( {D}_{0} )}^{2}} ) \cdot {[ 1 , 1 , 0.5 ]}^{T} , & i = 3\end{matrix}$$
wherein Wᵢ^{k} is the initial weight at P^{k}; D^{k}={square root over ((Δx^{e(k)})²+(Δx^{n(k)})²+(Δx^{u(k)})²)} is a distance between P^{k} and P⁰; D₀ is an inverse distance weighted attenuation factor;
the initial weight matrix Wᵢ of various observations is determined as:
Wᵢ=diag(Wᵢ′)
wherein Wᵢ′=[(Wᵢ¹)^{T}, (Wᵢ²)^{T}, . . . , (Wᵢ^{K}^{ᵢ})^{T}]^{T}; Wᵢ=diag(Wᵢ′) is a diagonal matrix whose diagonal elements are elements in the vector Wᵢ′ in sequence.

4. The InSAR and GNSS weighting method, as recited in claim 3, wherein the inverse distance weighted attenuation factor D₀ is determined as:
$${D}_{0} = \frac{1}{{K}^{′} {K}_{3}^{′}} {\sum }_{{k}^{′} = 1}^{{K}^{′}} {\sum }_{{k}_{s}^{′} = 1}^{{K}_{s}^{′}} {D}^{{k}^{′} {k}_{s}^{′}}$$
wherein K′ is a total quantity of GNSS sites in an entire deformation field, K′₃ represents a quantity of GNSS sites closest to P⁰; K′₃ ranges from 4 to 6; D^{k′k′}^{ₛ} is a distance between a site k′ among all K′ GNSS sites and a site k′₃ among the K′₃ GNSS sites closest to P⁰.

5. The InSAR and GNSS weighting method, as recited in claim 4, wherein the step 3 specifically comprising steps of:
determining the accurate weight matrix Ŵᵢ and a unit weight error a, of the various InSAR/GNSS observations by the variance component estimation, and solving the three-dimensional deformation d⁰ based on the least square method; wherein
Mᵢ=Bᵢ^{T}WⁱBᵢ,Nᵢ=Bᵢ^{T}WⁱLⁱ,M=Σᵢ₌₁³Mᵢ,N=Σᵢ₌₁³Nᵢ, then:
l=M⁻¹N (10)
and according to the variance component estimation:
σ²=Ψ⁻¹δ (11)
wherein,
σ²=[σ₁² σ₂² σ₃²]^{T} is unit weight error estimation of the various observations; Ψ is a transformation matrix; and δ is an observation correction quadratic vector;
updating the weight Wᵢ of the various observations by an equation (13):
$${\hat{W}}_{1} = {W}_{1} , {\hat{W}}_{2} = \frac{{σ}_{1}^{2}}{{σ}_{2}^{3} {W}_{2}^{- 1}} , {\hat{W}}_{3} = \frac{{σ}_{1}^{3}}{{σ}_{3}^{2} {W}_{3}^{- 1}}$$
using the equation (13) to update the weight of the observations, and then recalculating the equations (10) and (11); iterating the process until the unit weight error of the various observations satisfies a difference of σᵢ² is less than a threshold Δσ; and
obtaining a high-accurate three-dimensional surface deformation result according to the equation (10), which is 1^{st}, 2^{nd} and 3^{rd} elements of the unknown parameter vector l.

6. The InSAR and GNSS weighting method, as recited in claim 5, wherein the transformation matrix Ψ is:
$$Ψ = [ \begin{matrix}{K}_{1} - 2 tr ( {M}^{- 1} {M}_{1} ) + {tr ( {M}^{- 1} {M}_{1} )}^{2} & tr ( {M}^{- 1} {M}_{1} {M}^{- 1} {M}_{2} ) & tr ( {M}^{- 1} {M}_{1} {M}^{- 1} {M}_{3} ) \\ tr ( {M}^{- 1} {M}_{1} {M}^{- 1} {M}_{2} ) & {K}_{2} - 2 tr ( {M}^{- 1} {M}_{2} ) + {tr ( {M}^{- 1} {M}_{2} )}^{2} & tr ( {M}^{- 1} {M}_{2} {M}^{- 1} {M}_{3} ) \\ tr ( {M}^{- 1} {M}_{1} {M}^{- 1} {M}_{2} ) & tr ( {M}^{- 1} {M}_{2} {M}^{- 1} {M}_{3} ) & {K}_{3} - 2 tr ( {M}^{- 1} {M}_{3} ) + {tr ( {M}^{- 1} {M}_{3} )}^{2}\end{matrix} ] .$$

7. The InSAR and GNSS weighting method, as recited in claim 6, wherein the observation correction quadratic vector S is:
δ=[ν₁^{T}W₁ν₁ν₂^{T}W₂ν₂ν₃^{T}W₃ν₃]^{T}
wherein observation correction νᵢ=Bᵢ·l−Lᵢ.

8. The InSAR and GNSS weighting method, as recited in claim 7, wherein in iterating the process until the unit weight error of the various observations satisfies the difference σᵢ² is less than the threshold Δσ, Δσ²=1 mm².
